(19) United States
(12) Patent Application Publication
(10) Pub. No.: US 2026/0151712 A1
(43) Pub. Date: Jun. 4, 2026

(54) SYSTEM AND METHOD FOR ESTABLISHING A FORCED PERSPECTIVE ILLUSION

(71) Applicant: Universal City Studios LLC, Universal City, CA (US)

(72) Inventors: Angelo Pagliuca, Orlando, FL (US); Anthony Melo, Orlando, FL (US)

(21) Appl. No.: 19/405,534

(22) Filed: Dec. 2, 2025

Related U.S. Application Data
(60) Provisional application No. 63/727,477, filed on Dec. 3, 2024.

(51) Int. Cl. A63G 31/16; G06F 3/01

(52) U.S. Cl. CPC A63G 31/16; G06F 3/011

(57) ABSTRACT

A control system for establishing a forced perspective illusion includes a controller configured to control movement of a first portion of an object to cause the first portion of the object to move at a first speed with respect to an observer. The first portion of the object is positioned a first distance from the observer to establish a first visual angle. The controller is also configured to control movement of a second portion of the object to cause the second portion of the object to move at a second speed with respect to the observer. The second portion of the object is positioned a second distance from the observer, greater than the first distance, to establish a second visual angle, and the second speed is equal to the first speed multiplied by a ratio of the second visual angle to the first visual angle.

### CROSS-REFERENCE TO RELATED APPLICATION

This application claims priority from and the benefit of U.S. Provisional Application Ser. No. 63/727,477, entitled “SYSTEM AND METHOD FOR ESTABLISHING A FORCED PERSPECTIVE ILLUSION”, filed Dec. 3, 2024, which is hereby incorporated by reference in its entirety.

### BACKGROUND

The present disclosure relates generally to a system and method for establishing a forced perspective illusion.

Certain approaches to forced perspective illusions may be employed to influence the apparent size of an object or an apparent distance to the object. For example, to cause an object to appear closer to an observer than the actual distance between the object and the observer, the size of the object may be increased, thereby establishing a forced perspective illusion in which the object appears closer to the observer. However, if a portion of the object moves, especially in a direction toward the observer, the visual angle of the portion may vary significantly relative to the remainder of the object. As a result, the effectiveness of the forced perspective illusion may be substantially reduced, thereby enabling the observer to identify the actual size and distance of the object, which may degrade the experience.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the claimed subject matter. Indeed, the claimed subject matter may encompass a variety of forms that may be similar to or different from the embodiments set forth below.

In an embodiment, a control system for establishing a forced perspective illusion includes a controller having a processor and a memory. The controller is configured to control movement of a first portion of an object to cause the first portion of the object to move at a first speed with respect to an observer. The first portion of the object is positioned a first distance from the observer to establish a first visual angle. The controller is also configured to control movement of a second portion of the object to cause the second portion of the object to move at a second speed with respect to the observer. The second portion of the object is positioned a second distance from the observer, greater than the first distance, to establish a second visual angle, and the second speed is equal to the first speed multiplied by a ratio of the second visual angle to the first visual angle.

In an embodiment, a method for establishing a forced perspective illusion includes controlling, via a controller having a processor and a memory, movement of a first portion of an object to cause the first portion of the object to move at a first speed with respect to an observer. The first portion of the object is positioned a first distance from the observer to establish a first visual angle. The method also includes controlling, via the controller, movement of a second portion of the object to cause the second portion of the object to move at a second speed with respect to the observer. The second portion of the object is positioned a second distance from the observer, greater than the first distance, to establish a second visual angle, and the second speed is equal to the first speed multiplied by a ratio of the second visual angle to the first visual angle.

In an embodiment, an interactive environment includes an object having a first portion and a second portion. The first portion of the object is configured to be positioned a first distance from an observer to establish a first visual angle, and the second portion of the object is configured to be positioned a second distance from the observer, greater than the first distance, to establish a second visual angle. The interactive environment also includes a control system having a first actuator configured to move the first portion of the object, a second actuator configured to move the second portion of the object, and a controller having a memory and a processor. The controller is communicatively coupled to the first actuator and to the second actuator, and the controller is configured to control the first actuator to control movement of the first portion of the object to cause the first portion of the object to move at a first speed with respect to the observer. The controller is also configured to control the second actuator to control movement of the second portion of the object to cause the second portion of the object to move at a second speed with respect to the observer. The second speed is equal to the first speed multiplied by a ratio of the second visual angle to the first visual angle.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic view of an embodiment of an interactive environment;

FIG. 2 is a perspective view of an embodiment of an object that may be employed within the interactive environment of FIG. 1, in which the object has a first portion and a second portion, and the first and second portions are in a first position;

FIG. 3 is a perspective view of the object of FIG. 2, in which the first and second portions are in a second position;

FIG. 4 is a perspective view of the object of FIG. 2, in which the first and second portions are in a third position;

FIG. 5 is a schematic view of an embodiment of an object that may be employed within the interactive environment of FIG. 1;

FIG. 6 is a block diagram of an embodiment of a control system that may be employed within the interactive environment of FIG. 1; and

FIG. 7 is a flow diagram of an embodiment of a method for establishing a forced perspective illusion.

### DETAILED DESCRIPTION

One or more specific embodiments of the present disclosure will be described below. To provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

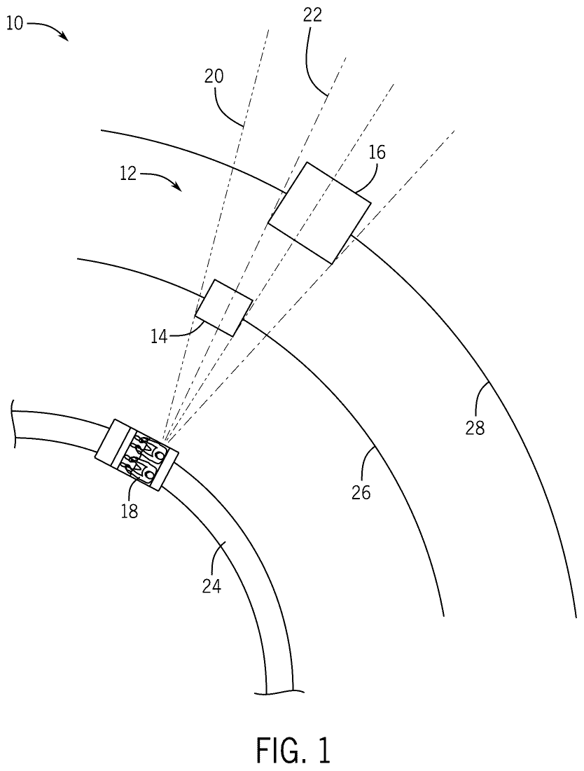

FIG. 1 is a schematic view of an embodiment of an interactive environment 10. In the illustrated embodiment, the interactive environment 10 includes an object 12 having a first portion 14 and a second portion 16. The first portion 14 of the object 12 is positioned a first distance from an observer 18 to establish a first visual angle 20. In addition, the second portion 16 of the object 12 is positioned a second distance from the observer 18, greater than the first distance, to establish a second visual angle 22. The object 12 may include any suitable elements or system viewable by the observer 18. For example, in an embodiment, the object 12 may include an animated figure, in which the first portion 14 includes a body of the animated figure, and the second portion 16 includes an implement.

The first portion 14 and the second portion 16 of the object 12 are positioned to establish a forced perspective illusion from the perspective of the observer 18. For example, the first distance may be selected to cause the first portion 14 of the object 12 to appear larger than the actual size of the first portion 14. In addition, the second distance may be selected to cause the second portion 16 of the object 12 to appear smaller than the actual size of the second portion 16. Furthermore, the first and second distances may be selected and the first and second portions may be located such that the object appears continuous from the perspective of the observer 18. As previously discussed, in an embodiment, the object 12 may include an animated figure, in which the first portion 14 includes a body of the animated figure, and the second portion 16 includes an implement. In such an embodiment, the first distance may be selected such that the body appears larger than the actual size of the body, the second distance may be selected such that the implement appears smaller than the actual size of the implement, and the first and second distances may be selected and the first and second portions may be located such that the implement appears to be held by the body of the animated figure, even though the body and the implement are separated from one another.

In an embodiment, the interactive environment 10 includes a control system configured to control movement of the first and second portions of the object to maintain the forced perspective illusion as the first and second portions move with respect to the observer 18. As discussed in detail below, the control system includes a first actuator configured to move the first portion 14 of the object 12, and the control system includes a second actuator configured to move the second portion 16 of the object 12. Furthermore, the control system includes a controller having a processor and a memory, in which the controller is communicatively coupled to the first and second actuators. The controller is configured to control the first actuator to control movement of the first portion 14 of the object 12 to cause the first portion 14 of the object 12 to move at a first speed with respect to the observer 18. In addition, the controller is configured to control the second actuator to control movement of the second portion 16 of the object 12 to cause the second portion 16 of the object 12 to move at a second speed with respect to the observer 18. The second speed is equal to the first speed multiplied by a ratio of the second visual angle 22 to the first visual angle 20. As a result, the visual angles may be maintained throughout the movement of the first and second portions of the object 12, thereby maintaining the apparent relationship between the first and second portions of the object (e.g., continuity of the object) from the perspective of the observer. Accordingly, the forced perspective illusion may be maintained as the first and second portions of the object 12 move.

In the illustrated embodiment, the observer 18 may translate and rotate through the interactive environment 10. Accordingly, the control system may be configured to rotate and translate the first and second portions of the object 12 to maintain the forced perspective illusion. In an embodiment, the control system may include a third actuator configured to control a first orientation of the first portion 14 of the object 12, and the control system may include a fourth actuator configured to control a second orientation of the second portion 16 of the object 12. The controller may be communicatively coupled to the third actuator and to the fourth actuator, and the controller may be configured to control the third actuator and the fourth actuator to control the first orientation of the first portion 14 and the second orientation of the second portion 16, respectively, based on a location (e.g., observer location) and/or an orientation (e.g., observer orientation) of the observer 18 to maintain alignment of the first portion 14 and the second portion 16 of the object 12 from the perspective of the observer, thereby maintaining the forced perspective illusion.

Furthermore, in an embodiment, the control system may include a fifth actuator configured to control a first location of the first portion 14 of the object 12, and the control system may include a sixth actuator configured to control a second location of the second portion 16 of the object 12. The controller may be communicatively coupled to the fifth actuator and to the sixth actuator, and the controller may be configured to control the fifth actuator and the sixth actuator to control the first location of the first portion 14 and the second location of the second portion 16, respectively, based on the location (e.g., observer location) and/or the orientation (e.g., observer orientation) of the observer 18 to maintain alignment of the first and second portions of the object 12 from the perspective of the observer 18, thereby maintaining the forced perspective illusion.

As illustrated, the observer 18 may follow an observer path 24 through the interactive environment 10. In an embodiment, the observer may rotate (e.g., as the observer moves along the observer path 24). In the illustrated embodiment, a first path 26 of the first portion 14 of the object 12 and a second path 28 of the second portion 16 of the object 12 may be parallel to a portion of the observer path 24 of the observer 18. In an embodiment, at least one path (e.g., each path) may be defined by a rail or track within the interactive environment. Furthermore, in an embodiment, at least one path (e.g., the first path 26 and the second path 28) may be defined by a rotating platform (e.g., carousel). In addition, the portion of the object 12 is configured to rotate relative to the respective path. For example, in an embodiment, the first portion 14 of the object 12 may be rotatably mounted to a first rotating platform, and the second portion 16 of the object 12 may be rotatably mounted to a second rotating platform. Furthermore, in an embodiment, the first portion 14 of the object 12 may be rotatably mounted to a first ride vehicle configured to move along the first path 26, and the second portion 16 of the object 12 may be rotatably mounted to a second ride vehicle configured to move along the second path 28. The controller may be configured to control the fifth actuator and the sixth actuator to control the first location of the first portion 14 of the object 12 along the first path 26 and the second location of the second portion 16 of the object 12 along the second path 28, respectively, based on the observer location along the observer path 24 and/or the observer orientation to maintain alignment of the first and second portions of the object 12 from the perspective of the observer 18. Furthermore, the controller may be configured to control the third actuator and the fourth actuator to control the first orientation of the first portion 14 (e.g., as the first portion 14 moves along the first path 26) and the second orientation of the second portion 16 (e.g., as the second portion 16 moves along the second path 28), respectively, based on the observer location and/or the observer orientation to maintain alignment of the first and second portions of the object 12 from the perspective of the observer 18.

While the first path 26 and the second path 28 are parallel to the illustrated portion of the observer path in the illustrated embodiment, in an embodiment, the first path 26 and/or the second path 28 may have another suitable shape to facilitate maintaining the forced perspective illusion as the observer 18 translates and/or rotates. In addition, while the observer 18, the first portion 14 of the object 12, and the second portion 16 of the object 12 are configured to follow fixed paths through the interactive environment 10 in the illustrated embodiment, in an embodiment, at least one of the observer 18, the first portion 14, or the second portion 16 may follow a respective variable path through the interactive environment. For example, at least one of the observer 18, the first portion 14, or the second portion 16 may be mounted to a respective steerable ride vehicle configured to move in any suitable direction within the interactive environment 10. While the first portion 14 and the second portion 16 of the object 12 are configured to rotate and translate in the illustrated embodiment, in an embodiment, at least one portion of the object 12 may be configured to only rotate or only translate based on the observer location and/or the observer orientation. Furthermore, while the observer 18 rotates and translates through the interactive environment 10 in the illustrated embodiment, in an embodiment, the observer 18 may only rotate within the interactive environment 10 or only translate through the interactive environment 10. In such an embodiment, the controller may be configured to control rotation and/or translation of the first portion 14 and the second portion 16 based on the observer location or the observer orientation. Furthermore, in an embodiment, the observer 18 may be stationary within the interactive environment 10. In such an embodiment, the third, fourth, fifth, and sixth actuators may be omitted, and the orientation and the location of each portion of the object 12 may not be controlled based on the observer location and/or the observer orientation.

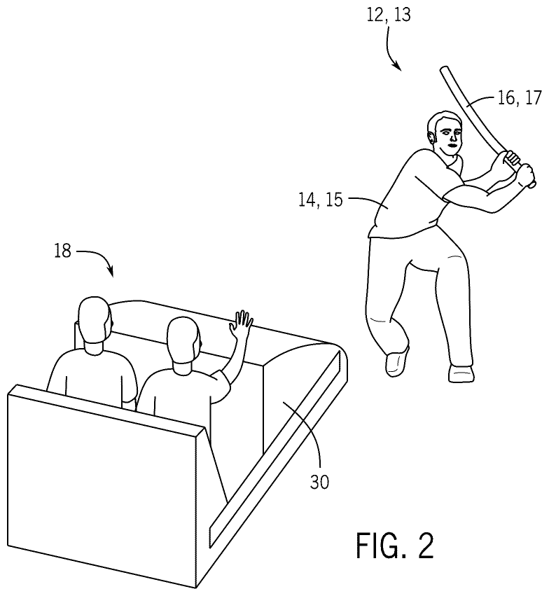

FIG. 2 is a perspective view of an embodiment of the object 12 that may be employed within the interactive environment 10 of FIG. 1, in which the object 12 has the first portion 14 and the second portion 16, and the first portion 14 and the second portion 16 are in a first position. As previously discussed, the first portion 14 of the object 12 is positioned a first distance from the observer 18 to establish the first visual angle 20, and the second portion 16 of the object 12 is positioned a second distance from the observer 18, greater than the first distance, to establish the second visual angle 22. In the illustrated embodiment, the object 12 includes an animated FIG. 13, in which the first portion 14 includes a body 15 (e.g., sports player, warrior, etc.) of the animated FIG. 13, and the second portion 16 includes an implement 17 (e.g., bat, sword, etc.). The first distance may be selected such that the body 15 appears larger than the actual size of the body 15, the second distance may be selected such that the implement 17 appears smaller than the actual size of the implement 17, and the first and second distances may be selected and the first and second portions may be located such that the implement 17 appears to be held by the body 15 of the animated FIG. 13, even though the body 15 and the implement 17 are separated from one another, thereby establishing a forced perspective illusion from the perspective of the observer 18.

As illustrated, the observer 18 may be positioned within a ride vehicle 30 that is configured to move along the observer path through the interactive environment, as discussed above. In an embodiment, the ride vehicle 30 may rotate (e.g., as the ride vehicle moves along the observer path). Accordingly, the observer 18 may translate through the interactive environment and rotate within the interactive environment. However, in an embodiment, the observer may only rotate within the interactive environment, only translate through the interactive environment, or be stationary within the interactive environment. Furthermore, while an observer positioned within a ride vehicle is disclosed above, in an embodiment, the observer may be positioned within another suitable structure or system, or the observer may not be positioned within any structure or system (e.g., the observer may stand within the interactive environment).

As discussed in detail below, the controller of the control system may be configured to control movement of the first portion 14 (e.g., body 15) to cause the first portion 14 (e.g., body 15) to move at a first speed with respect to the observer 18, and the controller may be configured to control movement of the second portion 16 (e.g., implement 17) to cause the second portion 16 (e.g., implement 17) to move at a second speed with respect to the observer 18. The second speed may be equal to the first speed multiplied by a ratio of the second visual angle 22 to the first visual angle 20. For example, to establish a forced perspective illusion of the body 15 swinging the implement 17, the controller may control movement of the body 15 (e.g., twisting movement) to cause the body 15 to move at a first speed with respect to the observer 18, and the controller may control movement of the implement 17 (e.g., translating and rotating movement) to cause the implement 17 to move at a second speed with respect to the observer 18. The controller may be configured to control movement of the body 15 and the implement 17 such that the second speed is equal to the first speed multiplied by a ratio of the second visual angle 22 to the first visual angle 20. As a result, the visual angles may be maintained throughout the movement of the body 15 and the implement 17, thereby maintaining the apparent relationship between the body 15 and the implement 17 (e.g., continuity of the animated FIG. 13) from the perspective of the observer 18. Accordingly, the forced perspective illusion may be maintained as the body 15 and the implement 17 move. As used herein, the speed of a portion (e.g., the first portion 14 or the second portion 16) with respect to the observer 18 refers to a speed of at least part of the portion in a direction toward the observer 18 (e.g., the speed of the fastest moving part of the portion in the direction toward the observer 18).

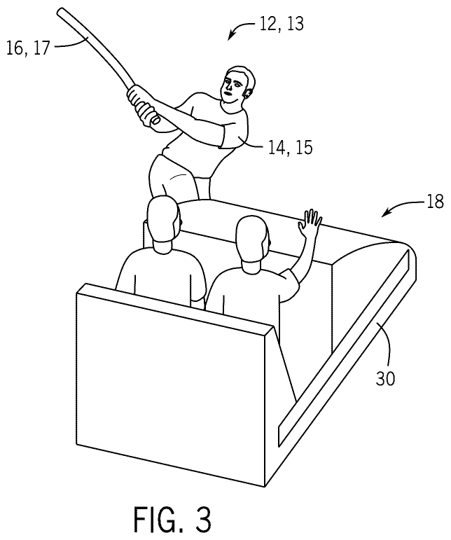

FIG. 3 is a perspective view of the object 12 of FIG. 2, in which the first portion 14 and the second portion 16 are in a second position. As illustrated, the body 15 of the animated FIG. 13 is in the second position (e.g., twisted relative to the first position of FIG. 2), and the implement 17 of the animated FIG. 13 is in the second position (e.g., translated and rotated relative to the first position of FIG. 2). Accordingly, the animated FIG. 13 is in a post-swing configuration, as compared to a pre-swing configuration of FIG. 2. Because the controller is configured to control movement of the body 15 and the implement 17 such that the second speed is equal to the first speed multiplied by a ratio of the second visual angle 22 to the first visual angle 20, the apparent relationship between the body 15 and the implement 17 (e.g., continuity of the animated FIG. 13) is maintained from the perspective of the observer. Accordingly, from the perspective of the observer 18, the body 15 of the animated FIG. 13 appears to swing the implement 17. In addition, because the implement 17 is farther from the observer and larger than the apparent size of the implement 17, the implement 17 may appear to be on a trajectory that intersects the observer 18, thereby enhancing the effectiveness of the forced perspective illusion throughout the range of motion of the animated FIG. 13 (e.g., as compared to an animated FIG. 13 in which the implement 17 is attached to the body 15 and the effectiveness of the forced perspective illusion is reduced as the implement 17 moves toward the observer 18).

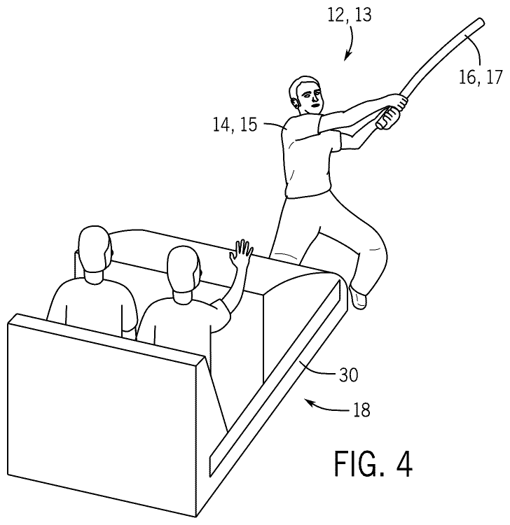

FIG. 4 is a perspective view of the object 12 of FIG. 2, in which the first portion 14 and the second portion 16 are in a third position. In an embodiment, the controller is configured to control movement of the first portion 14 and the second portion 16 of the object 12 based on input from the observer 18. As discussed in detail below, a user interface may be communicatively coupled to the controller. The user interface may receive input from the observer 18 and output a control signal to the controller indicative of the input. The controller, in turn, may control movement of the first portion 14 and the second portion 16 of the object 12 based on the input from the observer 18. For example, the user interface may receive an input indicative of instructions to terminate the swing of the implement 17. Accordingly, the controller may control the first and second actuators to cause the body 15 of the animated FIG. 13 to twist to a third position (e.g., from the first position of FIG. 2) and the implement 17 to rotate and translate to a third position (e.g., from the first position of FIG. 2). Accordingly, after the terminated swing, the animated FIG. 13 is in a terminated-swing configuration, as compared to the pre-swing configuration of FIG. 2. As previously discussed, because the controller is configured to control movement of the body 15 and the implement 17 such that the second speed is equal to the first speed multiplied by a ratio of the second visual angle 22 to the first visual angle 20, the apparent relationship between the body 15 and the implement 17 (e.g., continuity of the animated FIG. 13) is maintained from the perspective of the observer throughout the movement from the pre-swing configuration to the terminated-swing configuration.

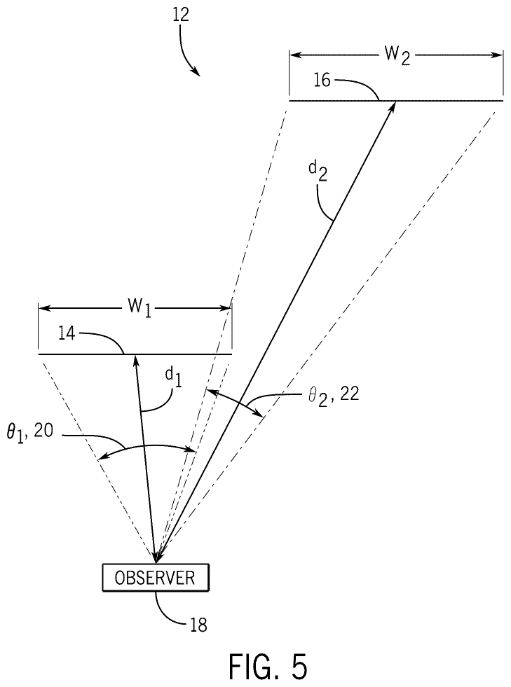

FIG. 5 is a schematic view of an embodiment of the object 12 that may be employed within the interactive environment of FIG. 1. As previously discussed, the object 12 includes the first portion 14 and the second portion 16. As illustrated, the first portion 14 is positioned a first distance d₁ from the observer 18, thereby establishing a first visual angle θ1, 20. In addition, the second portion 16 is positioned a second distance d₂ from the observer 18, thereby establishing a second visual angle θ2, 22. As illustrated, the second distance d₂ is greater than the first distance d₁. Furthermore, the first portion 14 has a first width w₁, and the second portion 16 has a second width w₂.

In an embodiment, the controller is configured to determine each of the first visual angle θ1, 20 and the second visual angle θ2, 22 with the equation:

$$θ = 2 {tan}^{- 1} \frac{w}{2 d} \qquad ( 1 )$$

where θ is the respective visual angle of the respective portion of the object 12, w is the width of the respective portion, and d is the respective distance of the respective portion from the observer 18.

However, if the distance is greater than twice the respective width, the visual angle may be approximated by the equation:

$$θ = \frac{w}{d} \qquad ( 2 )$$

where θ is the respective visual angle of the respective portion of the object 12 in radians, w is the width of the respective portion, and d is the respective distance of the respective portion from the observer 18. Accordingly, in an embodiment, the controller is configured to determine each visual angle in radians by dividing the respective width by the respective distance.

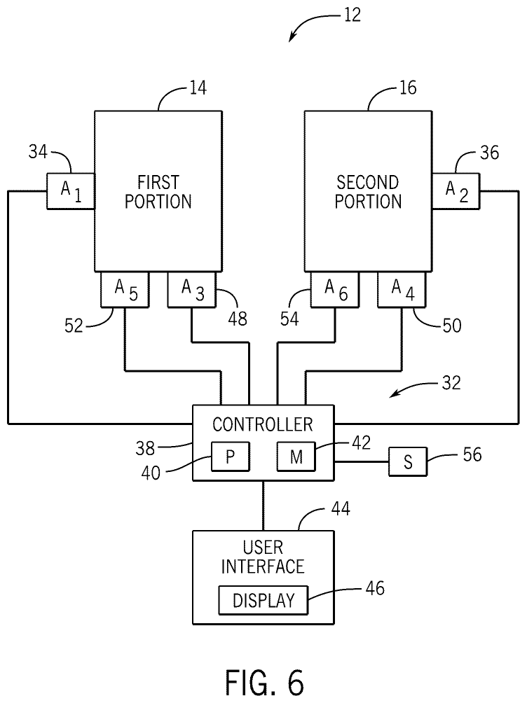

FIG. 6 is a block diagram of an embodiment of a control system 32 that may be employed within the interactive environment of FIG. 1. As previously discussed, the object 12 includes the first portion 14 and the second portion 16. The first portion 14 is configured to be positioned a first distance from the observer 18 to establish the first visual angle 20, and the second portion 16 is configured to be positioned a second distance from the observer 18, greater than the first distance, to establish the second visual angle 22. In the illustrated embodiment, the control system 32 includes a first actuator 34 configured to move the first portion 14 of the object 12, and the control system 32 includes a second actuator 36 configured to move the second portion 16 of the object 12. Each actuator may include any suitable type(s) of actuation device(s), such as electric linear actuator(s), pneumatic cylinder(s), hydraulic cylinder(s), electric motor(s), pneumatic motor(s), hydraulic motor(s), other suitable type(s) of actuation device(s), or a combination thereof. For example, in an embodiment, at least one actuator may include multiple actuation devices to move multiple components of the respective portion (e.g., arms, legs, and a torso of the body 15, etc.).

In the illustrated embodiment, the control system 32 includes a controller 38 communicatively coupled to the first actuator 34 and to the second actuator 36. In an embodiment, the controller 38 is an electronic controller having electrical circuitry configured to control the first actuator 34 and the second actuator 36. In the illustrated embodiment, the controller 38 includes a processor 40, such as a microprocessor. The controller 38 may also include one or more storage devices such as the illustrated memory device 42 and/or other suitable components. The processor 40 may be used to execute software, such as software for controlling the first actuator 34 and the second actuator 36, and so forth. Moreover, the processor 40 may include multiple microprocessors, one or more “general-purpose” microprocessors, one or more special-purpose microprocessors, one or more application specific integrated circuits (ASICs), one or more reduced instruction set computer (RISC) processors, or some combination thereof.

The memory device 42 may include a volatile memory such as random-access memory (RAM), and/or a nonvolatile memory such as read-only memory (ROM). The memory device 42 may store a variety of information and may be used for various purposes. For example, the memory device 42 may store processor-executable instructions (e.g., firmware or software) for the processor 40 to execute, such as instructions for controlling the first actuator 34 and the second actuator 36, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the first and second actuators, etc.), and any other suitable data.

In the illustrated embodiment, the control system 32 includes a user interface 44 communicatively coupled to the controller 38. The user interface 44 is configured to receive input from an operator and to provide information to the operator. The user interface 44 may include any suitable input device(s) for receiving input, such as a keyboard, a mouse, button(s), switch(es), knob(s), other suitable input device(s), or a combination thereof. In addition, the user interface 44 may include any suitable output device(s) for presenting information to the operator, such as speaker(s), indicator light(s), other suitable output device(s), or a combination thereof. In the illustrated embodiment, the user interface 44 includes a display 46 configured to present visual information to the operator. In an embodiment, the display 46 may include a touchscreen interface configured to receive input from the operator.

The controller 38 is configured to control the first actuator 34 to control movement of the first portion 14 of the object 12 to cause the first portion 14 of the object 12 to move at a first speed with respect to the observer 18. In addition, the controller 38 is configured to control the second actuator 36 to control movement of the second portion 16 of the object 12 to cause the second portion 16 of the object 12 to move at a second speed with respect to the observer 18. In an embodiment, the controller 38 determines the first visual angle 20 in radians by dividing the first width W₁ of the first portion 14 of the object 12 by the first distance d₁, and the controller 38 determines the second visual angle 22 in radians by dividing the second width W₂ of the second portion 16 of the object 12 by the second distance d₂. However, in an embodiment, the controller 38 may determine at least one visual angle by any other suitable technique, such as by using equation (1) above. Furthermore, in an embodiment, the controller 38 may determine at least one visual angle via feedback from a suitable sensor (e.g., camera, LiDAR sensor, etc.) directed toward the respective portion(s).

The controller 38 is configured to control the first actuator 34 and the second actuator 36 such that the second speed is equal to the first speed multiplied by a ratio of the second visual angle 22 to the first visual angle 20. As a result, the visual angles may be maintained throughout the movement of the first portion 14 and the second portion 16 of the object 12, thereby maintaining the apparent relationship between the first and second portions of the object (e.g., continuity of the object) from the perspective of the observer 18. Accordingly, the forced perspective illusion may be maintained as the first portion 14 and the second portion 16 of the object 12 move. In an embodiment, the controller 38 may determine the first speed (e.g., based on a desired movement, based on operator input, etc.) and then determine the second speed by multiplying the first speed by the ratio of the second visual angle 22 to the first visual angle 20. Furthermore, in an embodiment, the controller 38 may determine the second speed (e.g., based on a desired movement, based on operator input, etc.) and then determine the first speed by dividing the second speed by the ratio of the second visual angle 22 to the first visual angle 20.

In an embodiment, the controller 38 is configured to determine the first distance d₁ between the first portion 14 of the object 12 and the observer 18 based on the observer path 24 and the first path 26 of the first portion 14, and the controller 38 is configured to determine the second distance d₂ between the second portion 16 of the object 12 and the observer 18 based on the observer path 24 and the second path 28 of the second portion 16. For example, the controller 38 may determine the respective distance based on a stored position of the observer 18 along the observer path 24 as a function of time and a stored position of the respective portion of the object 12 along the respective path as a function of time. Furthermore, in an embodiment, the controller 38 may determine the location of the observer 18 (e.g., along the observer path 24) based on feedback from an observer location sensor, and/or the controller 38 may determine the location of at least one portion of the object 12 (e.g., along the respective path) based on feedback from a respective object portion location sensor. The controller 38 may then determine the respective distance based on the location of the observer 18 (e.g., as determined based on the stored observer location as a function of time or feedback from the observer location sensor) and the location of the respective portion of the object 12 (e.g., as determined based on the stored respective portion location as a function of time or feedback from the respective object portion location sensor). In addition, in an embodiment, the controller 38 may determine at least one respective distance based on feedback from distance sensor(s) configured to monitor the distance between the observer 18 and the respective portion of the object 12 (e.g., laser time-of-flight sensor(s), ultrasonic sensor(s), radar sensor(s), etc.).

In an embodiment, such as the embodiment disclosed above with reference to FIGS. 2-4, the object 12 includes an animated FIG. 13, in which the first portion 14 includes a body 15, and the second portion 16 includes an implement 17. In such an embodiment, the first actuator 34 may control movement of the body 15, and the second actuator 36 may control movement of the implement 17. For example, the first actuator 34 may control twisting of the body 15, and the second actuator 36 may control rotation and translation of the implement 17, thereby causing the animated FIG. 13d to appear to swing the implement 17 from the perspective of the observer 18, as discussed above with reference to FIGS. 2-4. While an implement 17 that appears connected to the body 15 is disclosed above, in an embodiment, the implement 17 may appear to separate from the body 15 from the perspective of the observer 18. For example, the implement 17 may include a ball (e.g., basketball, soccer ball, etc.) that is apparently thrown (e.g., tossed, dribbled, etc.) or kicked by the body 15 of the animated FIG. 13.

While a first portion 14 including a body 15 and a second portion 16 including an implement 17 are disclosed above, in an embodiment, the first portion 14 (e.g., the portion closer to the observer) may include an implement 17, and the second portion 16 (e.g., the portion farther from the observer) may include a body 15. Furthermore, the first portion 14 may include any suitable element(s), and the second portion 16 may include any suitable element(s). For example, in an embodiment, the first portion 14 may include an element that appears to be a projectile, and the second portion 16 may include a target. For example, the element that appears to be a projectile may be mounted on a vertically oriented disc that rotates about a rotational axis generally perpendicular to the observer 18. As the disc rotates, the element that appears to be a projectile may appear to move toward the target. The first actuator 34 may control rotation of the disc about the rotational axis, and the second actuator 36 may control movement of the target (e.g., to appear to avoid the projectile, to appear to react to impact from the projectile, etc.).

In an embodiment, the user interface 44 may receive an input from the observer 18 and output a control signal to the controller 38 indicative of the input from the observer 18. The controller 38, in turn, may control the first actuator 34 and the second actuator 36 to control the movement of the first and second portions based on the input from the observer 18. For example, as discussed above with reference to FIG. 4, the user interface 44 may receive an input from the observer 18 indicative of instructions to terminate the swing of the implement 17. Accordingly, the controller 38 may control the first actuator 34 and the second actuator 36 to cause the body 15 of the animated FIG. 13 to twist and the implement 17 to rotate and translate, such that the animated FIG. 13 transitions to the terminated-swing configuration. Furthermore, in an embodiment, the user interface 44 may receive an input to dribble a basketball, and the controller 38 may control the first actuator 34 and the second actuator 36 to cause the body 15 and the basketball to move accordingly. In addition, in an embodiment, the user interface 44 may receive an input to release the projectile toward the target, and the controller 38 may control the first actuator 34 and the second actuator 36 to cause the projectile to appear to move toward the target (e.g., by rotating the disc) and to cause the target to react to the projectile. While the control system 32 includes the user interface 44 in the illustrated embodiment, in an embodiment, the user interface 44 may be omitted.

In the illustrated embodiment, the control system 32 includes a third actuator 48 configured to control a first orientation of the first portion 14 of the object 12, and the control system 32 includes a fourth actuator 50 configured to control a second orientation of the second portion 16 of the object 12. Each actuator may include any suitable type(s) of actuation device(s), such as electric linear actuator(s), pneumatic cylinder(s), hydraulic cylinder(s), electric motor(s), pneumatic motor(s), hydraulic motor(s), other suitable type(s) of actuation device(s), or a combination thereof. For example, in an embodiment, at least one actuator may include multiple actuation devices configured to rotate the respective portion about multiple axes. As illustrated, the controller 38 is communicatively coupled to the third actuator 48 and to the fourth actuator 50. The controller 38 is configured to control the third actuator 48 and the fourth actuator 50 to control the first orientation of the first portion 14 and the second orientation of the second portion 16, respectively, based on a location (e.g., observer location) and/or an orientation (e.g., observer orientation) of the observer 18 to maintain alignment of the first portion 14 and the second portion 16 of the object 12 from the perspective of the observer 18, thereby maintaining the forced perspective illusion. Each of the third actuator 48 and the fourth actuator 50 may be configured to drive the respective portion to rotate relative to a base, such as the ride vehicle 30 or the rotating platform disclosed above.

Furthermore, in the illustrated embodiment, the control system 32 includes a fifth actuator 52 configured to control a first location of the first portion 14 of the object 12, and the control system 32 includes a sixth actuator 54 configured to control a second location of the second portion 16 of the object 12. Each actuator may include any suitable type(s) of actuation device(s), such as electric linear actuator(s), pneumatic cylinder(s), hydraulic cylinder(s), electric motor(s), pneumatic motor(s), hydraulic motor(s), other suitable type(s) of actuation device(s), or a combination thereof. For example, in an embodiment, at least one actuator may include multiple actuation devices configured to translate the respective portion along multiple axes. As illustrated, the controller 38 is communicatively coupled to the fifth actuator 52 and to the sixth actuator 54. The controller 38 is configured to control the fifth actuator 52 and the sixth actuator 54 to control the first location of the first portion 14 and the second location of the second portion 16, respectively, based on the location (e.g., observer location) and/or the orientation (e.g., observer orientation) of the observer 18 to maintain alignment of the first portion 14 and the second portion 16 of the object 12 from the perspective of the observer 18, thereby maintaining the forced perspective illusion. In an embodiment in which at least one portion of the object is mounted to a respective ride vehicle 30 (e.g., configured to move along a respective track), the respective actuator may be configured to drive the respective ride vehicle 30 to move (e.g., along the respective track). Furthermore, in an embodiment in which at least one portion of the object is mounted to a rotating platform, the respective actuator may be configured to drive the rotating platform to rotate.

In an embodiment, at least one actuator for at least one portion may perform multiple functions. For example, in an embodiment, a single actuator may move the first portion 14 of the object 12 at the first speed and translate the first portion 14 based on the observer location and/or the observer orientation, such that the single actuator corresponds to the first actuator 34 and the fifth actuator 52. Furthermore, in an embodiment, two actuators may move the second portion 16 of the object 12 at the second speed, translate the second portion 16 based on the observer location and/or the observer orientation, and rotate the second portion 16 based on the observer location and/or the observer orientation, such that the two actuators correspond to the second actuator 36, the fourth actuator 50, and the sixth actuator 54. Furthermore, in an embodiment in which the observer 18 is stationary with respect to the interactive environment 10, the third actuator 48, the fourth actuator 50, the fifth actuator 52, and the sixth actuator 54 may be omitted, and the controller 38 may not control the orientation and the location of each portion of the object 12 based on the observer location and/or the observer orientation.

In the illustrated embodiment, the control system 32 includes an observer sensor 56 communicatively coupled to the controller 38. The observer sensor 56 is configured to output a sensor signal indicative of the observer orientation and/or the observer location. The observer sensor 56 may include any suitable type(s) of sensing device(s) configured to monitor the observer location and/or the observer orientation. For example, the observer sensor 56 may include camera(s), infrared sensor(s), Hall effect sensor(s), ultrasonic sensor(s), other suitable type(s) of sensing device(s), or a combination thereof. While the control system 32 includes the observer sensor 56 in the illustrated embodiment, in an embodiment, the observer sensor 56 may be omitted. In such an embodiment, the controller 38 may determine the observer location and/or the observer orientation based on a stored location and/or orientation of the observer 18 as a function of time.

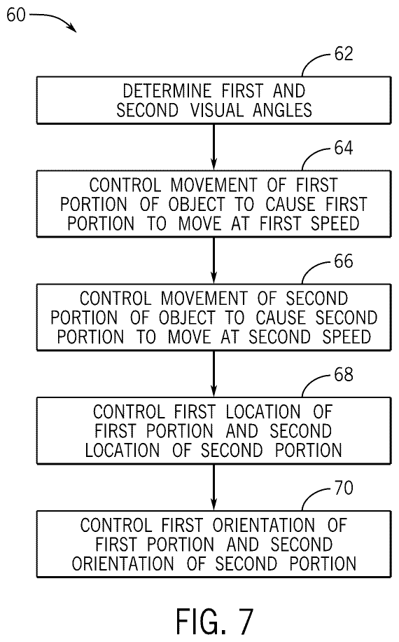

FIG. 7 is a flow diagram of an embodiment of a method 60 for establishing a forced perspective illusion. The method 60 may be performed by the controller 38 disclosed above with reference to FIG. 6, by one or more other suitable controllers, or a combination thereof. Furthermore, the steps of the method 60 may be performed in the order disclosed below or in any other suitable order. In addition, in an embodiment, one or more steps of the method 60 may be omitted, and/or the method may include one or more additional steps.

In the illustrated embodiment, the method 60 includes determining each of the first visual angle 20 and the second visual angle 22, as represented by block 62. In an embodiment, at least one visual angle may be determined using equation (2) above, in which the visual angle in radians is determined by dividing the respective width of the respective portion of the object by the distance between the respective portion of the object and the observer. Furthermore, in an embodiment, at least one visual angle may be determined using equation (1) above, and/or at least one visual angle may be determined based on feedback from a suitable sensor.

Furthermore, the method 60 includes controlling movement of the first portion 14 of the object 12 to cause the first portion 14 of the object 12 to move at a first speed with respect to the observer 18, as represented by block 64. As previously discussed, the first portion 14 of the object 12 is positioned a first distance d₁ from the observer 18 to establish the first visual angle 20. The first actuator 34 may be controlled to control movement of the first portion 14 to cause the first portion 14 to move at the first speed with respect to the observer 18.

The method 60 also includes controlling movement of the second portion 16 of the object 12 to cause the second portion 16 of the object 12 to move at a second speed with respect to the observer 18, as represented by block 66. As previously discussed, the second portion 16 of the object 12 is positioned a second distance d₂ from the observer 18, greater than the first distance d₁, to establish the second visual angle 22. The second actuator 36 may be controlled to control movement of the second portion 16 to cause the second portion 16 to move at the second speed with respect to the observer 18. The second speed is equal to the first speed multiplied by a ratio of the second visual angle 22 to the first visual angle 20. As a result, the visual angles may be maintained throughout the movement of the first portion 14 and the second portion 16 of the object 12, thereby maintaining the apparent relationship between the first portion 14 and the second portion 16 of the object 12 (e.g., continuity of the object) from the perspective of the observer 18. Accordingly, the forced perspective illusion may be maintained as the first portion 14 and the second portion 16 of the object 12 move. In an embodiment, the movement of the first portion 14 and the movement of the second portion 16 are controlled based on input from the observer 18, thereby enabling the observer 18 to at least partially control the object 12.

In an embodiment, the method 60 includes controlling a first location of the first portion 14 of the object 12 and a second location of the second portion 16 of the object 12 based on the observer location and/or the observer orientation to maintain alignment of the first portion 14 and the second portion 16 of the object 12 from the perspective of the observer 18, as represented by block 68. For example, as the observer 18 moves and/or rotates, the fifth actuator 52 and the sixth actuator 54 may be controlled to control the first location of the first portion 14 and the second location of the second portion 16, respectively, based on the observer location and/or the observer orientation to maintain alignment of the first portion 14 and the second portion 16 from the perspective of the observer 18. Furthermore, in an embodiment, the method 60 includes controlling a first orientation of the first portion 14 of the object 12 and a second orientation of the second portion 16 of the object 12 based on the observer location and/or the observer orientation to maintain alignment of the first portion 14 and the second portion 16 of the object 12 from the perspective of the observer 18, as represented by block 70. For example, as the observer 18 moves and/or rotates, the third actuator 48 and the fourth actuator 50 may be controlled to control the first orientation of the first portion 14 and the second orientation of the second portion 16, respectively, based on the observer location and/or the observer orientation to maintain alignment of the first portion 14 and the second portion 16 from the perspective of the observer 18.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A control system for establishing a forced perspective illusion, the control system comprising:
a controller comprising a processor and a memory, wherein the controller is configured to:
control movement of a first portion of an object to cause the first portion of the object to move at a first speed with respect to an observer, wherein the first portion of the object is positioned a first distance from the observer to establish a first visual angle; and
control movement of a second portion of the object to cause the second portion of the object to move at a second speed with respect to the observer, wherein the second portion of the object is positioned a second distance from the observer, greater than the first distance, to establish a second visual angle, and the second speed is equal to the first speed multiplied by a ratio of the second visual angle to the first visual angle.

2. The control system of claim 1, wherein the controller is configured to control a first location of the first portion of the object and a second location of the second portion of the object based on an observer location of the observer, an observer orientation of the observer, or a combination thereof, to maintain alignment of the first portion of the object and the second portion of the object from a perspective of the observer.

3. The control system of claim 1, wherein the controller is configured to control a first orientation of the first portion of the object and a second orientation of the second portion of the object based on an observer location of the observer, an observer orientation of the observer, or a combination thereof, to maintain alignment of the first portion of the object and the second portion of the object from a perspective of the observer.

4. The control system of claim 1, wherein the controller is configured to control the movement of the first portion of the object and to control the movement of the second portion of the object based on input from the observer.

5. The control system of claim 1, wherein the controller is configured to determine each of the first visual angle and the second visual angle with the equation:
$$\frac{w}{d}$$
where θ is a respective visual angle of a respective portion of the object in radians, w is a width of the respective portion, and d is a respective distance of the respective portion from the observer.

6. The control system of claim 1, wherein the object comprises an animated figure, the first portion of the object comprises a body of the animated figure, and the second portion of the object comprises an implement.

7. A method for establishing a forced perspective illusion, the method comprising:
controlling, via a controller comprising a processor and a memory, movement of a first portion of an object to cause the first portion of the object to move at a first speed with respect to an observer, wherein the first portion of the object is positioned a first distance from the observer to establish a first visual angle; and
controlling, via the controller, movement of a second portion of the object to cause the second portion of the object to move at a second speed with respect to the observer, wherein the second portion of the object is positioned a second distance from the observer, greater than the first distance, to establish a second visual angle, and the second speed is equal to the first speed multiplied by a ratio of the second visual angle to the first visual angle.

8. The method of claim 7, comprising controlling, via the controller, a first location of the first portion of the object and a second location of the second portion of the object based on an observer location of the observer, an observer orientation of the observer, or a combination thereof, to maintain alignment of the first portion of the object and the second portion of the object from a perspective of the observer.

9. The method of claim 7, comprising controlling, via the controller, a first orientation of the first portion of the object and a second orientation of the second portion of the object based on an observer location of the observer, an observer orientation of the observer, or a combination thereof, to maintain alignment of the first portion of the object and the second portion of the object from a perspective of the observer.

10. The method of claim 7, wherein controlling the movement of the first portion of the object and controlling the movement of the second portion of the object comprises controlling the movement of the first portion of the object and controlling the movement of the second portion of the object based on input from the observer.

11. The method of claim 7, comprising determining, via the controller, each of the first visual angle and the second visual angle with the equation:
$$θ = \frac{w}{d}$$
where θ is a respective visual angle of a respective portion of the object in radians, w is a width of the respective portion, and d is a respective distance of the respective portion from the observer.

12. The method of claim 7, wherein the object comprises an animated figure, the first portion of the object comprises a body of the animated figure, and the second portion of the object comprises an implement.

13. An interactive environment, comprising:
an object having a first portion and a second portion, wherein the first portion of the object is configured to be positioned a first distance from an observer to establish a first visual angle, and the second portion of the object is configured to be positioned a second distance from the observer, greater than the first distance, to establish a second visual angle; and
a control system, comprising:
a first actuator configured to move the first portion of the object;
a second actuator configured to move the second portion of the object; and
a controller comprising a memory and a processor, wherein the controller is communicatively coupled to the first actuator and to the second actuator, and the controller is configured to:
control the first actuator to control movement of the first portion of the object to cause the first portion of the object to move at a first speed with respect to the observer; and
control the second actuator to control movement of the second portion of the object to cause the second portion of the object to move at a second speed with respect to the observer, wherein the second speed is equal to the first speed multiplied by a ratio of the second visual angle to the first visual angle.

14. The interactive environment of claim 13, wherein the control system comprises:
a third actuator configured to control a first orientation of the first portion of the object; and
a fourth actuator configured to control a second orientation of the second portion of the object;
wherein the controller is communicatively coupled to the third actuator and to the fourth actuator, and the controller is configured to control the third actuator and the fourth actuator to control the first orientation of the first portion of the object and the second orientation of the second portion of the object, respectively, based on an observer location of the observer, an observer orientation of the observer, or a combination thereof, to maintain alignment of the first portion of the object and the second portion of the object from a perspective of the observer.

15. The interactive environment of claim 14, wherein the control system comprises:
a fifth actuator configured to control a first location of the first portion of the object; and
a sixth actuator configured to control a second location of the second portion of the object;
wherein the controller is communicatively coupled to the fifth actuator and to the sixth actuator, and the controller is configured to control the fifth actuator and the sixth actuator to control the first location of the first portion of the object and the second location of the second portion of the object, respectively, based on the observer location of the observer, the observer orientation of the observer, or a combination thereof, to maintain alignment of the first portion of the object and the second portion of the object from the perspective of the observer.

16. The interactive environment of claim 15, wherein the control system comprises an observer sensor communicatively coupled to the controller, and the observer sensor is configured to output a sensor signal indicative of the observer orientation, the observer location, or a combination thereof.

17. The interactive environment of claim 13, wherein the controller is configured to determine each of the first visual angle and the second visual angle with the equation:
$$θ = \frac{w}{d}$$
where θ is a respective visual angle of a respective portion of the object in radians, w is a width of the respective portion, and d is a respective distance of the respective portion from the observer.

18. The interactive environment of claim 13, wherein the control system comprises a user interface communicatively coupled to the controller, the user interface is configured to output a control signal indicative of input from the observer, and the controller is configured to control the movement of the first portion of the object and to control the movement of the second portion of the object based on the input from the observer.

19. The interactive environment of claim 13, wherein the object comprises an animated figure, the first portion of the object comprises a body of the animated figure, and the second portion of the object comprises an implement.

20. The interactive environment of claim 19, wherein the controller is configured to control the second actuator to move the implement, such that the implement appears to separate from the body from a perspective of the observer.
